(19) United States
(12) Patent Application Publication
(10) Pub. No.: US 2007/0202384 A1
(43) Pub. Date: Aug. 30, 2007

(54) Cell stack unit of fuel cell and fuel cell device with the same

(76) Inventors: Daisuke Watanabe, Ome-shi (JP); Akihiro Ozeki, Chiryu-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/708,940

(22) Filed: Feb. 20, 2007

(30) Foreign Application Priority Data
Feb. 28, 2006 (JP) 2006-053692

(51) Int. Cl. H01M 8/24; H01M 2/08

(52) U.S. Cl. 429/38; 429/35

(57) ABSTRACT

A cell stack unit includes a cell stack having single cells, separators, and end separators, fastening plates placed on the end separators, manifold members disposed on the sides of the cell stack in the stacking direction and including supply ports and discharge ports, and fuel supply passages and fuel discharge passages for flowing fuel, and oxidizer supply passages and oxidizer discharge passages for flowing oxidizer formed in the cell stack and manifold members. The fuel supply passages, the fuel discharge passages, the oxidizer supply passages, and the oxidizer discharge passages each have passages formed in the boundary between the end separator and the fastening plate and extending in the plane direction of the single cells, and passages each communicating with one of the supply port and the discharge port through the manifold member.

### CROSS-REFERENCE TO RELATED APPLICATIONS

This application is based upon and claims the benefit of priority from the Japanese Patent Application No. 2006-053692, filed Feb. 28, 2006, the entire contents of which are incorporated herein by reference.

### BACKGROUND

1. Field

An embodiment of the present invention relates to a cell stack unit of a fuel cell used as a power source for electronic devices, etc., and a fuel cell device with the same.

2. Description of the Related Art

Presently, a secondary battery, e.g., a lithium ion battery, is mainly used as a power source for electronic devices such as portable notebook personal computers (notebook PCs), mobile devices, etc. In recent years, high output miniature fuel cells that require no charging are expected as novel power sources, based on a demand for increased power consumption and prolonged operating time that are required by enhanced functions of the electronic devices. Among various types of fuel cells, a direct methanol fuel cell (DMFC) that uses a methanol solution as its fuel can handle the fuel more easily and has a simpler system than fuel cells that use hydrogen as their fuel. Accordingly, the DMFC is noticed as a promising power source for the electronic devices.

Normally, the fuel cell has a cell stack structure in which single cells and separators are alternately stacked. The single cell has a structure in which an electrolyte layer such as an electrolyte plate or a solid polymer electrolyte membrane is disposed between a fuel electrode and an oxidizer electrode. The separator has channels as reaction gas passages, which are formed on both sides thereof.

The single cell in the DMFC has a membrane electrode assembly (MEA) in which a fuel electrode and an oxidizer electrode, each containing a catalyst layer and a carbon paper are integrally formed on both sides of the polymer electrolyte membrane. The cell stack is constructed by alternately stacking separators and single cells. The separator has a fuel passage formed in a major surface thereof opposed to the fuel electrode of the single cell, an air passage in another major surface thereof opposed to the oxidizer electrode of the single cell, and vertical holes for supplying fuel and oxidizer to the passages or for discharging them from the passages. End separators having pipe functions to supply the fuel and oxidizer are placed respectively on the upper surface and the lower surface of the cell stack. Fastening plates are further placed on the outer sides of the end separators, respectively. The resultant stacked structure is clamped by a clamping tool such as claming screws to thereby complete a cell stack unit.

To incorporate the DMFC into a small electronic device, it is required to reduce the size and the thickness of the cell stack unit. In the cell stack unit in which the single cells are horizontally stacked, when the singles cells are reduced in the plane direction with the intention of reducing the device thickness, the area of the MEA becomes small with respect to the area of the separator. This reduces the area efficiency. In the cell stack unit in which the single cells are vertically stacked, fuel supply ports and fuel discharge ports are arranged in the stacking direction. This hinders the device thickness reduction. Jpn. Pat. Appln. KOKAI Publication No. 2005-293981 proposes a fuel cell in which a resin manifold plate having the pipe functions is clamped between the end separator and the fastening plate, and the fuel supply ports and the fuel discharge ports are arranged in the direction orthogonal to the stacking direction.

The proposed fuel cell allows the fuel and oxidizer supply and discharge ports, which are drawbacks for reducing the thickness, to be located on the side of the cell stack unit. This fuel cell is advantageous in reducing the device thickness. However, it is necessary to place the relatively thick manifold plates containing pipe arrangements therein on the upper and the lower sides of the cell stack unit. This forms a factor to increase the thickness of the cell stack unit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing a fuel cell device according to a first embodiment of the present invention;

FIG. 2 is an exemplary perspective view showing the fuel cell device coupled to a personal computer;

FIG. 3 is an exemplary perspective view showing the inner construction of the fuel cell device;

FIG. 4 is an exemplary perspective view showing a cell stack unit of the fuel cell device;

FIG. 5 is an exemplary cross sectional view showing a stack structure of the cell stack unit and passage arrangements;

FIG. 6 is an exemplary perspective view showing a single cell of the cell stack unit;

FIG. 7 is an exemplary enlarged cross sectional view showing an upper portion of the cell stack unit;

FIG. 8 is an exemplary perspective view showing a first major surface of a separator of the cell stack unit;

FIG. 9 is an exemplary perspective view showing a second major surface of the separator of the cell stack unit;

FIG. 10 is an exemplary perspective view showing a first major surface of an end separator of the cell stack unit;

FIG. 11 is an exemplary perspective view showing a second major surface of the end separator of the cell stack unit;

FIG. 12 is an exemplary exploded perspective view showing a portion of communication grooves of the cell stack unit;

FIG. 13 is an exemplary perspective view showing a cell stack unit according to a second embodiment of the invention;

FIG. 14 is an exemplary perspective view showing a cell stack unit according to a third embodiment of the invention; and

FIG. 15 is an exemplary perspective view showing a cell stack unit according to a fourth embodiment of the invention.

### DETAILED DESCRIPTION

Various embodiments according to the invention will be described hereinafter with reference to the accompanying drawings. In general, according to one embodiment of the invention, there is provided a cell stack unit comprising: a cell stack structure including a plurality of single cells each having an anode and a cathode, which are oppositely disposed, separators each having a fuel passage which supplies fuel to the anode of the single cell and an oxidizer passage which supplies oxidizer to the cathode, and being sandwiched between the adjacent single cells, the separators and the single cells being alternately stacked, and two end separators being placed on both ends of the cell stack structure as viewed in the stacking direction, and each having a fuel passage which supplies fuel to the anode or an oxidizer passage which supplies oxidizer to the cathode; two fastening plates respectively placed on the end separators; manifold members opposed to the side of the cell stack structure and extending in the stacking direction of the cell stack structure, each manifold member including supply ports and discharge ports; and fuel supply passages which supply fuel to the fuel passages, fuel discharge passages which flow the fuel discharged from the fuel passages, oxidizer supply passages which supply oxidizer to the oxidizer passages, and oxidizer discharge passages which flow the oxidizer discharged from the oxidizer passages, each formed in the cell stack structure and the manifold members,

the fuel supply passages, the fuel discharge passages, the oxidizer supply passages, and the oxidizer discharge passages being formed in a boundary between the end separator and the fastening plate, and having passages extending in the plane direction of the single cells and passages communicating with one of the supply port and the discharge port through the manifold member.

According to another aspect of the invention, there is provided a fuel cell device comprising: an electromotive section which has a cell stack unit and generates electric power by chemical reaction; a fuel tank which stores fuel therein and supplies fuel to the electromotive section; and an air supply section which supplies air to the electromotive section, the cell stack unit including a cell stack structure including a plurality of singles cells each having an anode and a cathode, which are opposed to each other, separators each having a fuel passage which supplies fuel to the anode of the single cell and an oxidizer passage which supplies oxidizer to the cathode, and being sandwiched between the adjacent single cells, the separators and the single cells being alternately stacked, and two end separators being placed on both ends of the cell stack structure as viewed in the stacking direction, and each having a fuel passage which supplies fuel to the anode or an oxidizer passage which supplies oxidizer to the cathode; two fastening plates respectively placed on the end separators; manifold members disposed to be opposed to the side of the cell stack structure and extending in the stacking direction of the cell stack structure, each manifold member including supply ports and discharge ports; and fuel supply passages which supply fuel to the fuel passages, fuel discharge passages which flow the fuel discharged from the fuel passages, oxidizer supply passages which supply oxidizer to the oxidizer passages, and oxidizer discharge passages which flow the oxidizer discharged from the oxidizer passages, each formed in the cell stack structure and the manifold members, and the fuel supply passages, the fuel discharge passages, the oxidizer supply passages, and the oxidizer discharge passages being formed in the boundary between the end separator and the fastening plate, and having passages extending in the plane direction of the single cells and passages communicating with one of the supply port and the discharge port through the manifold member.

A fuel cell device according to a first embodiment of the present invention will be described with reference to the accompanying drawings.

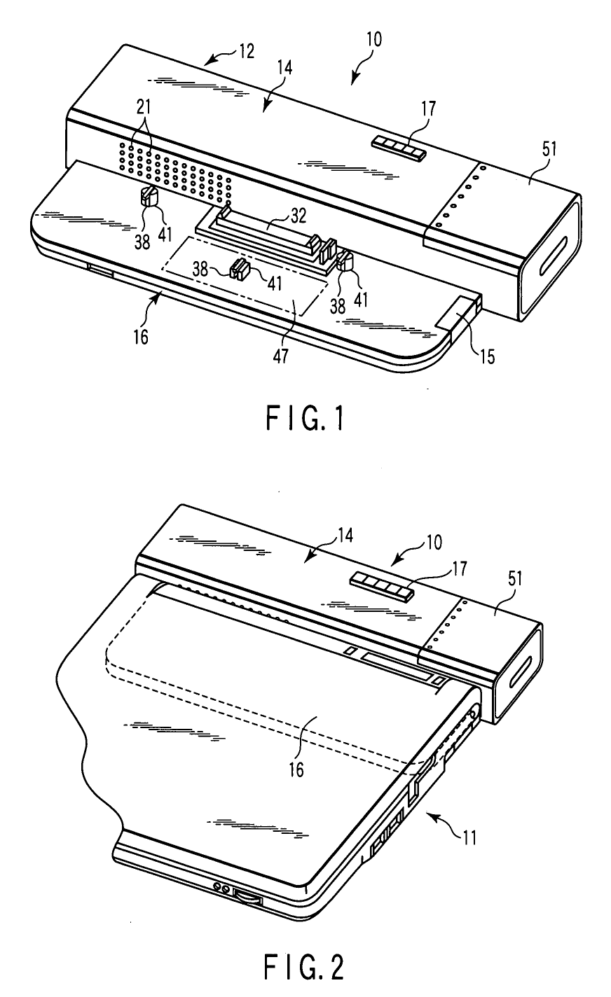

FIG. 1 shows an outward appearance of the fuel cell device, and FIG. 2 shows the fuel cell device coupled to a personal computer. A fuel cell device 10 is constructed in the form of, for example, a DMFC using methanol as liquid fuel, and may be used as a power source for such an electronic device as a personal computer 11.

The fuel cell device 10 is provided with a case 12. The case 12 includes a body 14, which is shaped like a rectangular column and is disposed extending in the width direction of the personal computer 11, and a bearer portion 16, which substantially horizontally extends from the body to the front side. As described later, a fuel cell unit is placed in the body 14. One side of the body 14 is formed as a cover 51, which can be removed at the time of attaching and detaching a fuel cartridge. A plurality of indicators 17 are provided in the upper surface of the body 14. The indicators serve as indicator means for indicating device operation statuses and a quantity level of the residual fuel in the fuel cartridge. Further, the main body 14 includes a plurality of air suction holes 21 and discharging holes, not shown.

The bearer portion 16 is flat and rectangular in shape so as to receive the rear part of the personal computer 11. A power connector 32 is disposed on the bearer portion 16. The connector 32 is electrically connected to the personal computer 11 when the personal computer 11 is placed on the bearer portion 16. Positioning projections 41 and hooks 38, which form a locking mechanism, are provided at three positions of the bearer portion 16. The positioning projections 41 and the hooks 38 engage with the rear part of the bottom of the personal computer 11, to thereby position the personal computer 11 to the bearer portion 16 and to hold it there. The bearer portion 16 includes an eject button 15, which unlocks the locking mechanism when the personal computer 11 is removed from the fuel cell device 10.

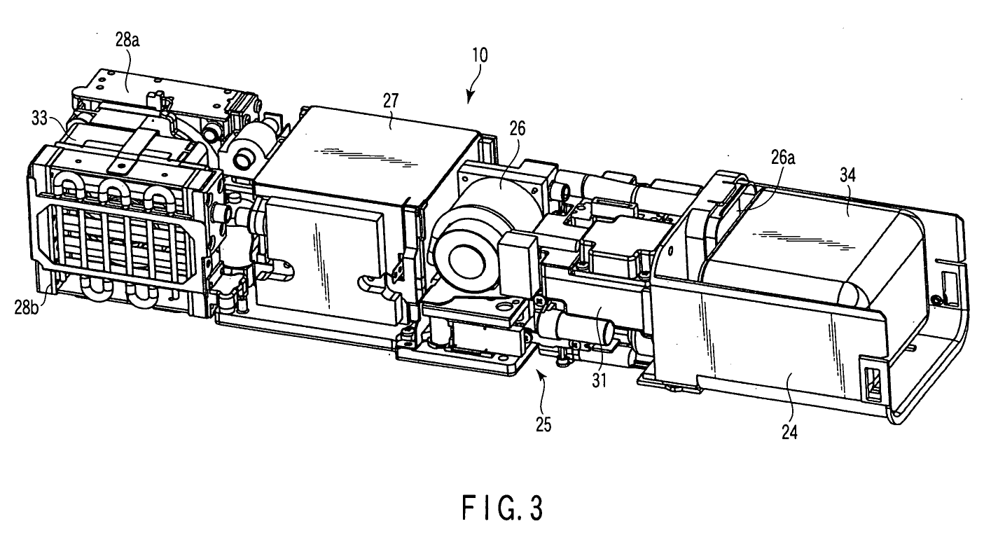

FIG. 3 shows a fuel cell unit 20 placed in the main body 14. The fuel cell unit 20 includes a holder 24 on one side thereof. A fuel cartridge 34 serving as a fuel tank is detachably attached to the holder. The fuel cell unit 20 includes an electromotive section 27, located at the central part thereof, for generating electric power through a chemical reaction, a mixing section 25 and an air suction section 26, which are provide between the electromotive section and the fuel cartridge 34, anode cooler 28a and a cathode cooler 28b, which are provided on the other side, and a cooling fan 33 located between these coolers. Additionally, the fuel cell unit 20 includes liquid pumps, air pumps, and various types of pipes for piping fuel, water, carbon dioxide, etc. The mixing section 25 includes a mixing tank 31.

Fuel is supplied from the fuel cartridge 34 to the mixing tank 31 where the fuel is mixed with water to be diluted into a methanol aqueous solution having a desired concentration. The mixing section 25 feeds the generated methanol aqueous solution to the electromotive section 27. The air suction section 26, which serves as an air supply section, introduces air that is taken through an air suction hole 26a from exterior, into the fuel cell unit 20, and supplies the air as an oxidizer to the electromotive section 27.

As described later, the electromotive section 27 is formed with a cell stack unit 45 having a cell stack structure containing an alternate stack of a plurality of single cells, separators and end separators. The electromotive section 27 chemically reacts the supplied methanol aqueous solution with the oxygen in the air introduced to thereby generate electric power. As the result of the power generation operation, carbon dioxide and steam are generated. The generated carbon dioxide, steam and unreacted methanol are sent to a cooler 28.

The anode cooler 28a and the cathode cooler 28b cool the carbon dioxide, steam and unreacted methanol generated in the electromotive section 27. The water resulting from the cooling of the steam and the unreacted methanol are returned to the mixing section 25, and are used for forming a methanol aqueous solution. The generated carbon dioxide is discharged to outside of the body 14.

As shown in FIG. 1, a control section 47 for controlling operations of the fuel cell device 10 is provided in the bearer portion 16. The control section 47 supervises the mixing section 25, the air suction section 26, the electromotive section 27, and the anode cooler 28a, the cathode cooler 28b and the cooling fan 33, and controls the operations of these sections and coolers. The control section 47 also supplies the electric power generated in the electromotive section 27 to the personal computer 11, through the connector 32.

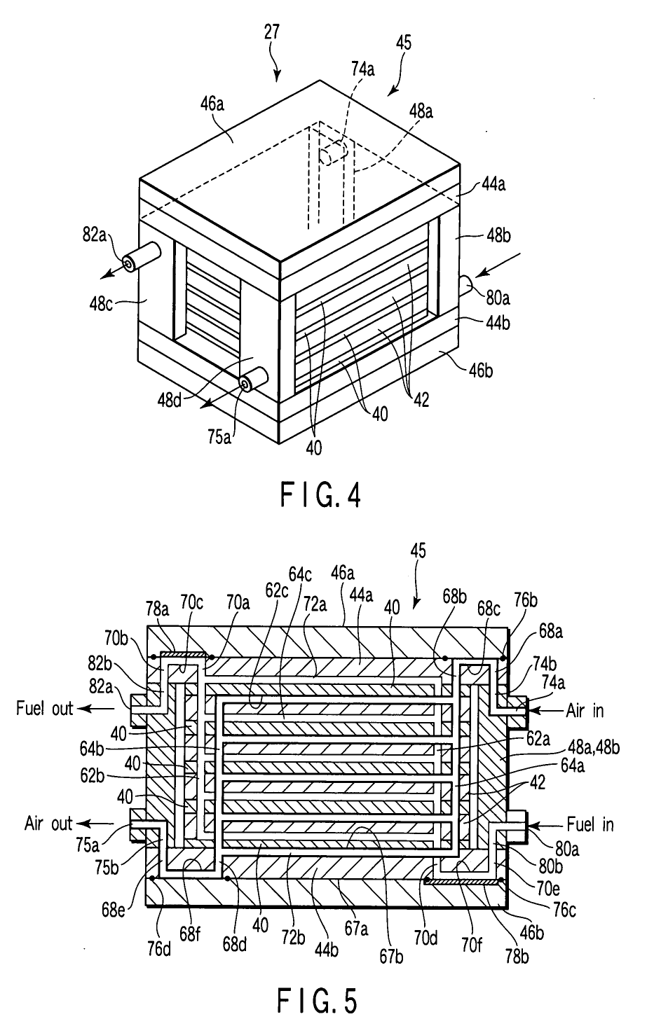

A structural arrangement of the electromotive section 27 will be described hereunder. The electromotive section 27 is provided with the cell stack unit 45. As shown in FIGS. 4 to 7, the cell stack unit 45 has a cell stack structure containing an alternate stack of a plurality of (five, for example) single cells 40, four separators 42 each shaped like a rectangular plate, and end separators 44a and 44b each shaped like a rectangular plate.

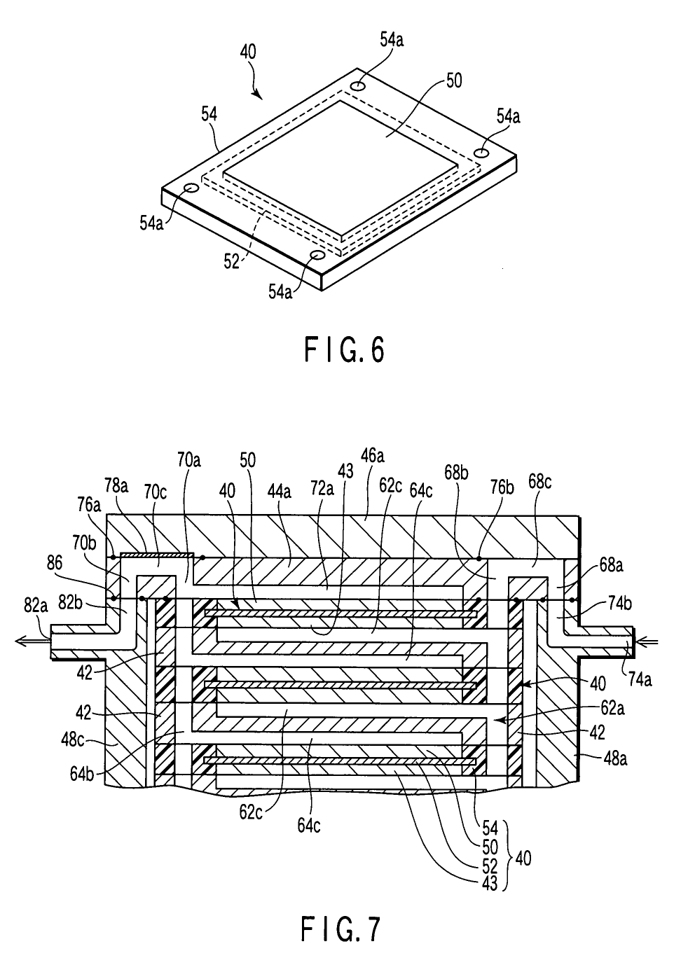

As shown in FIGS. 6 and 7, each single cell 40 includes a membrane electrode assembly (MEA), which contains a rectangular-plate-shaped cathode (air electrode) 43 and an anode (fuel electrode) 50, each formed with a catalyst layer and a carbon paper, a rectangular polymer electrolyte membrane 52 sandwiched between the cathode and the anode, and a rectangular packing 54 surrounding the MEA. The polymer electrolyte membrane 52 is larger in area than the cathode 43 and the anode 50, and its peripheral edge outwardly protrudes from the peripheral edges of the anode and the cathode. The packing 54 is equal in thickness to the MEA, and the single cell 40 is rectangular in its entire shape. Passage holes 54a are formed at the four corners of the packing 54.

Each separator 42 is placed between the two adjacent single cells 40, and the outside configuration of the separator 42 is substantially the same as that of the single cell 40, and the separators and the single cells are stacked while being aligned with one another. The two end separators 44a and 44b are placed on both ends of the single cells 40 as viewed in the stacking direction, and extend in the direction perpendicular to the stacking direction. The end separators 44a and 44b are larger in size than the single cells 40, and the peripheral edges of the end separators outwardly extend beyond the peripheral edges of the single cells.

The cell stack unit 45 includes two fastening plates 46a and 46b made of metal. The fastening plates 46a and 46b are rectangular in shape, and are equal in plane size to the end separators 44a and 44b. The fastening plates 46a and 46b are located on both ends of the single cells 40 as viewed in the stacking direction, and placed on the outer sides of the end separators 44a and 44b, respectively.

The cell stack unit 45 has manifold members, which extend in the stacking direction of the cell stack structure and are located on the sides of the cell stack structure. In the present embodiment, the manifold members include two manifold members 48a and 48b as first manifold members and two manifold members 48c and 48d as second manifold members. The manifold members 48a and 48b, each bar-like members, are disposed between the peripheral edges of the two end separators 44a and 44b on one side of the cell stack structure. The manifold members 48c and 48d, each bar-like members, are disposed between the peripheral edges of the two end separators 44c and 44d on the other side of the cell stack structure.

The cell stack structure, which is constructed with the single cells 40, the separators 42, the end separators 44a and 44b, and the fastening plates 46a and 46b, are fastened in the stacking direction by fastening means such as screws, not shown, into one unit. At this time, the manifold members 48a and 48b, and 48c and 48d are clamped between the peripheral edges of the end separators 44a and 44b to define a height of the cell stack structure and to prevent crush of the single cells 40.

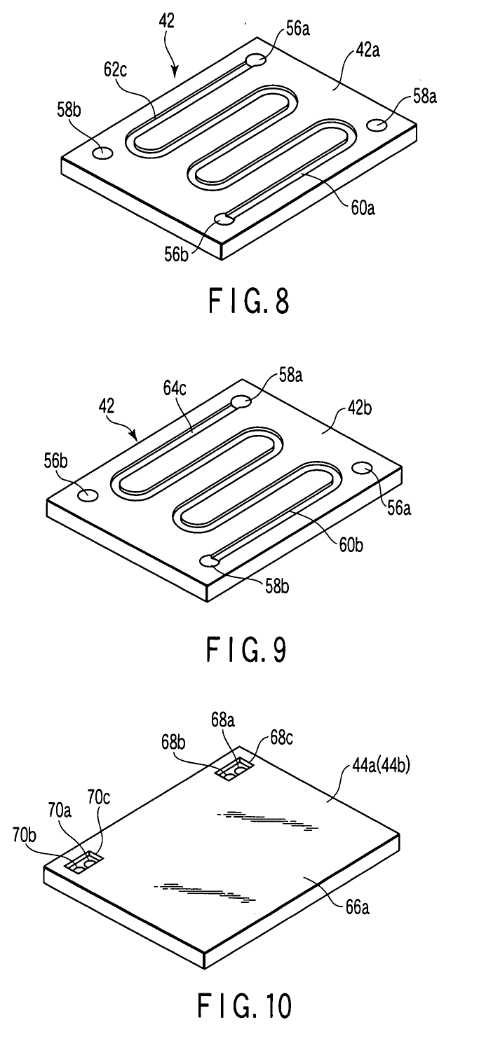

As shown in FIGS. 5, and 7 to 9, each separator 42 has a first major surface 42a, which is opposed to and contacts the cathode 43 of the single cell 40, and a second major surface 42b, which is opposed to and contacts the anode 50 of another single cell 40. Passage holes 56a and 56b, and 58a and 58b pass through the four corners of each separator 42. A narrow groove 60a is formed and zigzagged over the entire area of the first major surface 42a of each separator 42. The narrow groove 60a communicatively connects the two passage holes 56a and 56b of the separator 42, which are diagonally separated from each other, and extends therebetween. The narrow groove 60a defines an air branching passage 62c to be described later. A narrow groove 60b is formed and zigzagged over the entire area of the second major surface 42b of each separator 42. The narrow groove 60b communicatively connects the two passage holes 58a and 58b, which are separated from each other in the diagonal direction of the separators 42, and extends therebetween. The narrow groove 60b defines an air branching passage 64c to be described later.

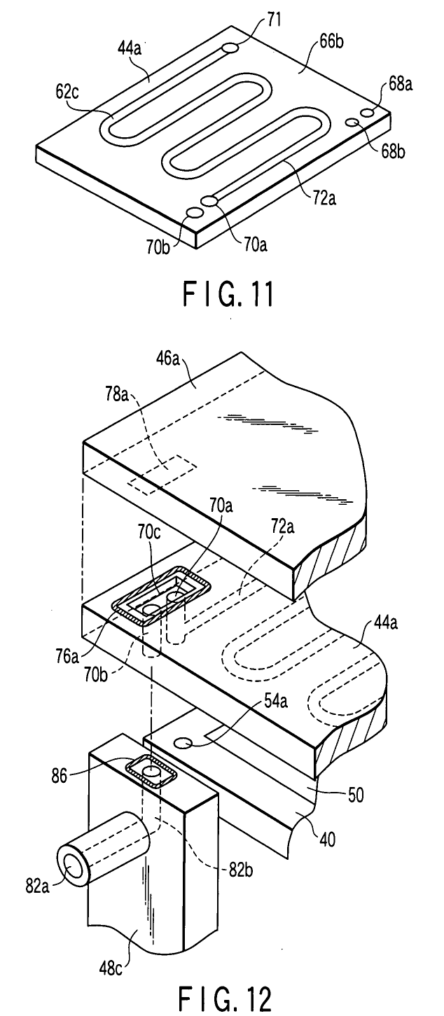

As shown in FIGS. 7, 10 and 11, the end separator 44a has a first major surface 66a which is opposed to and contacts the fastening plate 46a, a second major surface 66b which is opposed to and contacts the anode 50 of the single cell 40, and a second major surface 47b which is opposed to and contacts the fastening plate 46a. Two passage holes 68a and 68b, and 70a and 70b are formed to pass through the end separator 44a at the two adjacent corners of the end separator. A communicating groove 68c located on the passage holes 68a and 68b is formed in the first major surface 66a of the end separator 44a. These passage holes extend in the plane direction of the first major surface, i.e., the direction perpendicular to the stacking direction of the single cells 40. The passage holes 68a and 68b communicate with each other through the communicating groove 68c. A communicating groove 70c located on the passage holes 70a and 70b is formed in the first major surface 66a of the end separator 44a. These passage holes extend in the plane direction of the first major surface, i.e., the direction orthogonal to the stacking direction of the single cells 40. The passage holes 70a and 70b communicate with each other through the communicating groove 70c.

A passage recess 71 is formed at a corner of the second major surface 66b of the end separator 44a, which is diagonally opposite to the passage holes 70a and 70b. A narrow groove 72a is formed and zigzagged over the entire area of the second major surface 66b. The narrow groove 72a communicatively connects the passage hole 70a and the passage recess 71, which are separated from each other in the diagonal direction of the end separator 44a, and extends therebetween. The narrow groove 72a defines an air branching passage 64c to be described later.

As shown in FIGS. 7 and 12, an opening part of the communicating groove 70c of the end separator 44a is closed by the fastening plate 46a to define a closed passage. Specifically, a passage is formed in the boundary between the end separator 44a and the fastening plate 46a, i.e., the first major surface of the end separator 44a in this instance. An annular sealing material 76a is disposed around the communicating groove 70c in the boundary between the first major surface 66a of the end separator 44a and the fastening plate 46a, thereby to liquid-tightly seal the communicating groove. A portion of the inner surface of the fastening plate 46a, which is opposed to the communicating groove 70c, is coated with a protecting film (protecting layer) 78a, made of a material inactive to the fuel, such as Teflon™. The protecting film 78a protects the fastening plate 46a from its corrosion. The coating by the material inactive to the fuel may be replaced by a protecting sheet made of the material inactive to the fuel.

Similarly, the communicating groove 68c of the end separator 44a is closed by the fastening plate 46a to define a closed passage. Specifically, a passage is formed in the boundary between the end separator 44a and the fastening plate 46a, i.e., the first major surface of the end separator 44a in this instance. An annular sealing material 76b is disposed around the communicating groove 68c in the boundary between the first major surface 66a of the end separator 44a and the fastening plate 46a, thereby to liquid-tightly seal the communicating groove.

As shown in FIG. 5, the other end separator 44b is constructed like the end separator 44a. In addition, the end separator 44b has a first major surface 67a which is opposed to and abuts against the fastening plate 46b, a second major surface 67b which is opposed to and contacts the cathode 43 of the single cell 40, passage holes 68d and 68e, and 70d and 70e, communicating grooves 68f and 70f, the passage recess 71, and a groove 72b defining the air branching passage 62c.

An opening part of a communicating groove 70f of the end separator 44b is closed by the fastening plate 46b to define a closed passage. Specifically, a passage is formed in the boundary between the end separator 44b and the fastening plate 46b, i.e., the first major surface 67a of the end separator 44b in this instance. A ring-shaped sealing material 76c is disposed around the communicating groove 70f in the boundary between the first major surface 67a of the end separator 44b and the fastening plate 46b, thereby to liquid-tightly seal the communicating groove. A portion of the inner surface of the fastening plate 46b, which is opposed to the communicating groove 70f, is coated with a protecting film (protecting layer) 78b, made of a material inactive to the fuel, such as Teflon™. The protecting film 78a protects the fastening plate 46a from its corrosion. The coating by the material inactive to the fuel may be replaced by a protecting sheet made of the material inactive to the fuel.

The communicating groove 68f of the end separator 44b is likewise closed by the fastening plate 46b to define a closed passage. Specifically, a passage is formed in the boundary between the end separator 44b and the fastening plate 46b, i.e., the first major surface 67a of the end separator 44b in this instance. A ring-shaped sealing material 76d is disposed around the communicating groove 68f in the boundary between the first major surface 67a of the end separator 44b and the fastening plate 46b, thereby to liquid-tightly seal the communicating groove.

Air passages for flowing air and fuel passages for flowing fuel are formed in the cell stack unit 45. The cell stack unit 45 includes an air supply passage 62a, extending in the stacking direction of the single cells 40 for supplying air to the single cells, an air discharge passage 62b, extending in the stacking direction of the single cells 40 in the cell stack unit for discharging air from the single cells, and a plurality of air branching passages 62c which are branched from the air supply passage 62a, supply air to the cathodes 43 of the single cells, and are connected to the air discharge passage 62b.

The air supply passage 62a includes the stacked passage holes 54a of the single cells 40, the passage hole 56a of each separator 42, the passage holes 68a and 68b of the end separator 44a, and the communicating groove 68c. Formed in the manifold member 48a are an air supply port 74a protruded in the direction orthogonal to the stacking direction of the single cells 40, and a passage hole 74b extending from the air supply port 74a to the upper end of the manifold member 48a. The passage hole 74b communicates with the passage hole 68a of the end separator 44a and forms a part of the air supply passage 62a.

The air branching passage 62c is defined by the narrow groove 60a formed in the first major surface 42a of the separator 42 and the groove 72b formed in the second major surface 67b of the end separator 44b. Each air branching passages 62c is formed and zigzagged over the entire area of the cathode 43.

An air discharge passage 62b is defined by the passage holes 54a of the single cells 40 stacked, the passage hole 56b of each separator 42, the passage holes 68d and 68e of the end separator 44b, and the communicating groove 68f. As shown in FIGS. 4 and 5, formed in the manifold member 48d are an air discharge port 75a extending in the direction orthogonal to the stacking direction of the single cell 40, and a passage hole 75b extending from the air supply port to the lower end of the manifold member 48d. The passage hole 75b communicates with the passage hole 68e of the end separator 44b, and forms a part of the air discharge passage 62b.

The cell stack unit 45 has a fuel supply passage 64a which extends in the stacking direction of the single cells 40 and supplies fuel, i.e., methanol aqueous solution in this instance, to the single cells, a fuel discharge passage 64b which extends in the stacking direction of the single cells and discharges fuel from the single cells, and a plurality of fuel branching passages 64c which are branched from the fuel supply passage 64a, supply fuel to the anode 50 of each single cell 40, and are connected to the fuel discharge passage 64b.

The fuel supply passage 64a includes the passage holes 54a of the stacked single cells 40, the two passage holes 58a of each separator 42, the passage holes 70d and 70e of the end separator 44b, and the communicating groove 70f. Formed in the manifold member 48b are a fuel supply port 80a protruded in the direction orthogonal to the stacking direction of the single cells 40, and a passage hole 80b extending from the fuel supply port to the lower end of the manifold member 48b. The passage hole 80b communicates with the passage hole 70e of the end separator 44b, and defines a part of the air supply passage 64a.

The fuel branching passages 64c is defined by the narrow groove 60b formed in the second major surface 42b of the separator 42 and the narrow groove 72a formed in the second major surface 66b of the end separator 44a. Each fuel branching passage 64c is zigzagged over the entire area of the anode 50.

The fuel discharge passage 64b includes the passage holes 54a of the stacked single cells 40, the passage holes 58b of each separator 42, the passage holes 70a and 70b of the end separator 44a, and the communicating groove 70c. As shown in FIGS. 4 and 5, formed in the manifold member 48c are a fuel discharge port 82a protruding in the direction orthogonal to the stacking direction of the single cells 40, and a passage hole 82b extending from the fuel discharge port to the upper end of the manifold member 48c. The passage hole 82b communicates with the passage hole 70b of the end separator 44a and forms a part of the fuel discharge passage 64b.

A ring-shaped sealing material 86 is clamped between each of the upper ends of the manifold members 48a and 48b, and 48c and 48d and the end separator 44a, and between the lower end of the manifold members and the end separator 44b, thereby to liquid-tightly and air-tightly seal the air supply passages, the air discharge passages, the fuel supply passages, and the fuel discharge passages.

The electromotive section 27 thus constructed is disposed within the body 14 with the stacking direction of the single cells 40 extending in the direction substantially perpendicular to the bottom wall of the body. With such a construction, the single cells 40, the separators 42, the end separators 44a and 44b, the fastening plates 46a and 46b are substantially horizontally arranged and parallel to the bottom wall of the body 14.

The air supply port 74a of the cell stack unit 45 is connected to the air suction section 26 of the fuel cell unit 20 through a pipe arrangement (not shown). The air discharge port 75a is connected to the cathode cooler 28b through the pipe arrangement (not shown). The fuel supply port 80a of the cell stack unit 45 is connected to the mixing section 25 through the pipe arrangement (not shown). The fuel discharge port 82a is connected to the anode cooler 28a through the pipe arrangement (not shown).

In the case where the fuel cell device 10 is used as a power source of the personal computer 11, the rear end of the personal computer is placed on and locked to the bearer portion 16, and is electrically connected to the latter via the connector 32. In this state, the power generation by the fuel cell device 10 starts. In this case, methanol is supplied from the fuel cartridge 34 to the mixing section 25, and it is diluted to a predetermined concentration by water as solvent that is circulatively returned from the electromotive section 27. A methanol aqueous solution that results from the dilution in the mixing section 25 is supplied to the cell stack unit 45 of the electromotive section 27.

As shown in FIG. 5, the methanol aqueous solution fed from the mixing section 25 is sent from the fuel supply port 80a of the cell stack unit 45 to the fuel supply passage 64a, and flows from the fuel supply passage to the plurality of fuel branching passages 64c. When the methanol aqueous solution flows through the fuel branching passages 64c, it is supplied to the anodes 50 of their associated single cells 40. The methanol aqueous solution having passed through the fuel branching passages 64c meets in the fuel discharge passage 64b, and is discharged from the fuel discharge port 82a to an anode passage, not shown.

The air fed from the air suction section 26 is sent from the air supply port 74a of the cell stack unit 45 to the air supply passage 62a, and flows from the air supply passage to the plurality of air branching passages 62c. When the air flows through the air branching passages 62c, it is supplied to the cathodes 43 of their corresponding single cells 40. The air having passed through the air branching passages 62c meets in the air discharge passage 62b and is discharged from the air discharge port 75a to a cathode passage, not shown.

The methanol aqueous solution and the air having thus been supplied to the single cells 40 chemically react with each other in the polymer electrolyte membrane 52 located between the anode 50 and the cathode 43, so that electric power is generated between the anode 50 and the cathode 43. The electric power generated in the electromotive section 27 is supplied to the personal computer 11 by way of the control section 47 and the connector 32.

As the power generation reaction proceeds, carbon dioxide and water are, respectively, produced as reaction products at the anodes 50 and the cathodes 43 in the electromotive section 27. The carbon dioxide generated in the anodes 50 and unreacted methanol solution are discharged from the fuel discharge port 82a, and sent to a gas-liquid separator, not shown. In the separator, the carbon dioxide is separated and discharged. The methanol is sent to the anode cooler 28a where it is cooled and then returned to the mixing tank 31.

Most of the water generated at the cathodes 43 becomes steam, and is discharged from the air discharge port 75a, together with the air. The discharged water is sent to a reservoir, not shown, and then to the mixing tank 31. The air and the steam are sent to the cathode cooler 28b where those are cooled and part of them is condensed into water. The water is sent to the reservoir and then to the mixing tank 31.

With the fuel cell device 10 thus constructed, the air supply port 74a, the air discharge port 75a, the fuel supply port 80a, and the fuel discharge port 82a of the cell stack unit 45 are arranged in the direction orthogonal to the stacking direction of the single cells 40, i.e., the plane direction of the single cell. Such an arrangement of the air supply port 74a, the air discharge port 75a, the fuel supply port 80a, and the fuel discharge port 82a more reduces a thickness of the cell stack unit in the stacking direction than an arrangement of these ports in the stacking direction of the single cell. This can result in thickness reduction of the whole fuel cell device 10.

Parts of the air supply passages, the air discharge passage, the fuel supply passage, and the fuel discharge passage that communicate with the air supply port 74a, the air discharge port 75a, the fuel supply port 80a, and the fuel discharge port 82a, which are provided on each side of the cell stack, are defined by the communication grooves which are formed in the boundary between the end separator and the fastening plate and extend in the plane direction of the single cell. With this structural feature, the air supply passages, the air discharge passage, the fuel supply passage, and the fuel discharge passage can be formed without thickening the end separator and the fastening plate, and without locating the manifold member between the end separator and the fastening plate. The result is that the thickness of the cell stack unit as viewed in the stacking direction is further reduced.

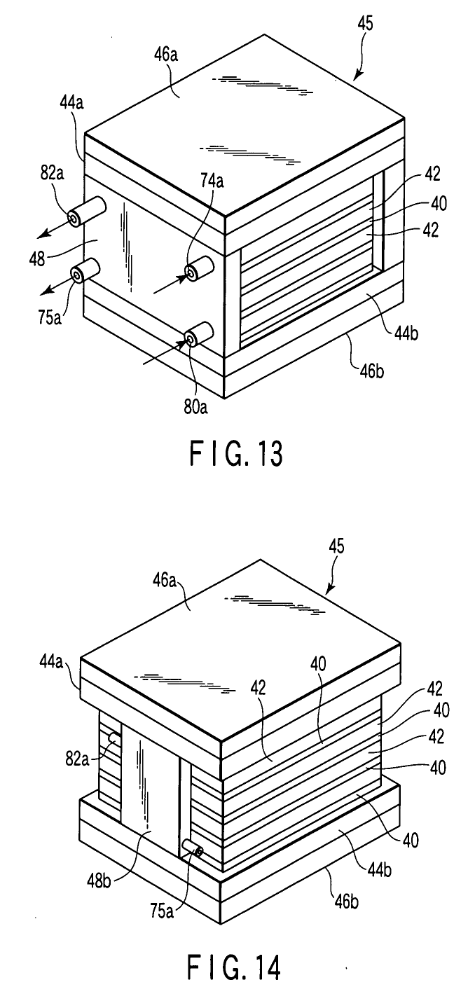

In the embodiment mentioned above, the air supply port 74a, the air discharge port 75b, the fuel supply port 80a, and the fuel discharge port 82a of the cell stack unit 45 are provided on both sides of the cell stack. However, those may be provided on one side of the cell stack, as shown in FIG. 13. The manifold members 48 are rectangular in shape, and extend in the stacking direction of the single cells 40. In addition, those are clamped between the two end separators 44a and 44b. The air supply port 74a, the air discharge port 75b, the fuel supply port 80a, and the fuel discharge port 82a are formed in the manifold member 48 and arranged in the direction orthogonal to the stacking direction of the single cells 40. The air supply passages, the air discharge passage, the fuel supply passage, and the fuel discharge passage of the cell stack unit 45 are constructed as in the first embodiment mentioned above, and some of them extend in the plane direction of the single cells in the boundary between the end separator and the fastening plate.

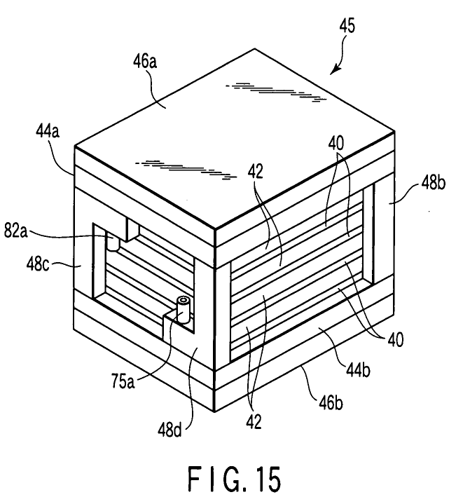

The air supply port 74a, the air discharge port 75a, the fuel supply port 80a, and the fuel discharge port 82a may be arranged on the side of the cell stack, i.e., in the direction orthogonal to the stacking direction of the single cells 40, and extend in this direction, and then are bent in the horizontal direction as shown in FIG. 14. In an alternative, as shown in FIG. 15, these ports may be arranged so as to extend from the side of the cell stack in the direction orthogonal to the stacking direction of the single cells 40, and to be then bent in the stacking direction, i.e., vertically in this instance.

In the embodiments shown in FIGS. 13, 14 and 15, the remaining construction of the cell stack unit 45 is substantially the same as in the first embodiment. Accordingly, like reference numerals are used for designating like or equivalent portions, for simplicity. It is readily understood that the operations and the useful effects of the embodiments shown in FIGS. 13, 14 and 15 are comparable with those of the first embodiment.

While certain embodiments of the inventions have been described, these embodiments have been presented by way of example only, and are not intended to limit the scope of the inventions. Indeed, the novel methods and systems described herein may be embodied in a variety of forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

It is evident that the number of the single cells in the cell stack unit is not limited to that of the embodiments mentioned above, but may be varied as required. The communication grooves forming the passages in the cell stack unit may be formed in the fastening plate or both the fastening plate and the end separator in the boundary between the end separator and the fastening plate. Further, the fuel cell constructed according to the present invention may be applied to a power source of a mobile device, mobile terminals, etc., in addition to the personal computer. The type of fuel cell is not limited to the DMFC, but may be PEFC (polymer electrolyte fuel cell) or the like.

What is claimed is:

1. A cell stack unit comprising:
a cell stack structure including a plurality of single cells each having an anode and a cathode, which are oppositely disposed, separators each having a fuel passage which supplies fuel to the anode of the single cell and an oxidizer passage which supplies oxidizer to the cathode, and being sandwiched between the adjacent single cells, the separators and the single cells being alternately stacked, and two end separators being placed on both ends of the cell stack structure as viewed in the stacking direction, and each having a fuel passage which supplies fuel to the anode or an oxidizer passage which supplies oxidizer to the cathode;
two fastening plates respectively placed on the end separators;
manifold members opposed to the side of the cell stack structure and extending in the stacking direction of the cell stack structure, each manifold member including supply ports and discharge ports; and
fuel supply passages which supply fuel to the fuel passages, fuel discharge passages which flow the fuel discharged from the fuel passages, oxidizer supply passages which supply oxidizer to the oxidizer passages, and oxidizer discharge passages which flow the oxidizer discharged from the oxidizer passages, each formed in the cell stack structure and the manifold members,
the fuel supply passages, the fuel discharge passages, the oxidizer supply passages, and the oxidizer discharge passages being formed in a boundary between the end separator and the fastening plate, and having passages extending in the plane direction of the single cells and passages communicating with one of the supply port and the discharge port through the manifold member.

2. The cell stack unit according to claim 1, wherein the passages formed in the boundary between the end separator and the fastening plate are defined by a communication groove formed in at least one of the end separator and the fastening plate.

3. The cell stack unit according to claim 1, further comprising a protecting layer made of a material inactive to fuel, formed in the fastening plate and confronted with the passages formed in the boundary between the end separator and the fastening plate.

4. The cell stack unit according to claim 1, further comprising a sealing material clamped between the end separator and the fastening plate and located around the passages formed in the boundary between the end separator and the fastening plate.

5. The cell stack unit according to claim 1, wherein the end separator is larger in size than the single cell, and has a peripheral edge protruded to the periphery of the single cell, and the manifold members are provided between the peripheral edges of the two end separators and extend in the stacking direction of the cell stack structure.

6. The cell stack unit according to claim 5, wherein
the manifold members are provided on both sides of the cell stack structure, sandwiching the cell stack structure,
the manifold members include a first manifold member and a second manifold member, both being located between the peripheral edges of the end separators,
the supply ports are formed in the first manifold member, and
the discharge ports are formed in the second manifold member.

7. A fuel cell device comprising:
an electromotive section which has a cell stack unit and generates electric power by chemical reaction;
a fuel tank which stores fuel therein and supplies fuel to the electromotive section; and
an air supply section which supplies air to the electromotive section,
the cell stack unit including a cell stack structure including a plurality of singles cells each having an anode and a cathode, which are opposed to each other, separators each having a fuel passage which supplies fuel to the anode of the single cell and an oxidizer passage which supplies oxidizer to the cathode, and being sandwiched between the adjacent single cells, the separators and the single cells being alternately stacked, and two end separators being placed on both ends of the cell stack structure as viewed in the stacking direction, and each having a fuel passage which supplies fuel to the anode or an oxidizer passage which supplies oxidizer to the cathode;
two fastening plates respectively placed on the end separators;
manifold members disposed to be opposed to the side of the cell stack structure and extending in the stacking direction of the cell stack structure, each manifold member including supply ports and discharge ports; and
fuel supply passages which supply fuel to the fuel passages, fuel discharge passages which flow the fuel discharged from the fuel passages, oxidizer supply passages which supply oxidizer to the oxidizer passages, and oxidizer discharge passages which flow the oxidizer discharged from the oxidizer passages, each formed in the cell stack structure and the manifold members, and
the fuel supply passages, the fuel discharge passages, the oxidizer supply passages, and the oxidizer discharge passages being formed in the boundary between the end separator and the fastening plate, and having passages extending in the plane direction of the single cells and passages communicating with one of the supply port and the discharge port through the manifold member.

8. The fuel cell device according to claim 7, wherein the passages formed in the boundary between the end separator and the fastening plate are defined by a communication groove formed in at least one of the end separator and the fastening plate.

9. The fuel cell device according to claim 7, wherein the end separator is larger in size than the single cell, and has a peripheral edge protruded to the periphery of the single cell, and the manifold members are provided between the peripheral edges of the two end separators and extend in the stacking direction of the cell stack structure.
